(19) United States
(12) Patent Application Publication
(10) Pub. No.: US 2009/0241184 A1
(43) Pub. Date: Sep. 24, 2009

(54) METHOD FOR GENERATING ACCESS DATA FOR A MEDICAL DEVICE

(75) Inventor: Axel Doering, Jena (DE)

Correspondence Address: PATTERSON, THUENTE, SKAAR & CHRISTENSEN, P.A., 4800 IDS CENTER, 80 SOUTH 8TH STREET, MINNEAPOLIS, MN, 55402-2100, US

(73) Assignee: CARL ZEISS MEDITEC AG, Jena (DE)

(21) Appl. No.: 12/374,921

(22) PCT Filed: Jul. 19, 2007
(86) PCT No.: PCT/EP07/06403

§ 371 Date: Jan. 23, 2009

(30) Foreign Application Priority Data
Jul. 26, 2006 (DE) 102006034536.3

(51) Int. Cl. G06F 21/00

(52) U.S. Cl. 726/18

(57) ABSTRACT

A method for generating an access code to a medical device including a memory for patient data, the access code being valid only once. According to the method, a query key is generated from a device-internal identification and is transmitted to an authorization entity. The authorization entity generates an associated release key from the query key. The release key grants access and modifies the internal identification when the release key is entered into the device such that the access code cannot be used a second time.

### PRIORITY CLAIM

The present application is a National Phase entry of PCT Application No. PCT/EP2007/006403, filed Jun. 19, 2007, which claims priority from German Application Number 102006034536.3, filed Jul. 26, 2006, the disclosures of which are hereby incorporated by reference herein in their entirety.

### FIELD OF THE INVENTION

The invention relates to a method for generating access data for a medical device, which contains a secured memory for medical or patient data.

### BACKGROUND OF THE INVENTION

The access to patient data, which are recorded or stored in medical devices, is subject to strict legal requirements. The minimum requirement is always the identification and authorization of the device user, who is authorized to access said data. However, the loss of said access authorization is a practical relevant complication (e.g., forgotten password, previous user leaves clinic/office without correct information transfer).

In principle, the data which authorize access (usually user code/password) can be kept in a secure location (sealed envelope in a safe). Even though the regular changes of passwords are one of the basic safety measures, it is difficult to ensure, in practical terms, that the stored password is the most current one. This method also requires the cooperation of the (previous) user, which may not necessarily be a given.

A usual method involves hidden access without authorization (e.g., secret key combination, service user code with unchangeable password—“secret masterkey”), known only to a limited number of people (e.g., service personnel), which provides direct access to the data or allows for the reset of the lost access to a known or definable value. Said method cannot ensure an effective and traceable protection of patient data because it depends on the fact that only trustworthy persons are provided with the knowledge regarding the secret masterkey. In practical terms, this is not feasible and, particularly, the confidentiality involved is difficult to trace.

The use of a physically protected key (e.g., a dongle at the USB or parallel port) prevents the uncontrolled disclosure of access information (as with the secret masterkey) and facilitates the proof of manipulations carried out with the help of the physically protected key (reset of lost access). However, it requires the physical presence of an authorized person (e.g., authorized service employee), which requires time and money.

Furthermore, access protection is compromised for all devices, once a physically protected key has been misappropriated or duplicated.

### SUMMARY OF THE INVENTION

The task, solved by the invention, consists of the controlled release of a lost access authorization without physical manipulation of the data-storing device.

In this context, controlled release means that the method cannot be misused in order to gain access to a device other than the one identified, and that said access method becomes ineffective immediately after its use, therefore not constituting a “masterkey” even for said identified device.

Said task is solved through a method for generating an access code for a medical device or system, said access code being valid only once, which includes the following steps:

a) Device-internal generating of a query key from at least one device-internal identification;

b) Transmission of the query key to an authorization entity;

c) Generation of a release key from the query key through the authorization entity;

d) Transmission of the release key to the device;

e) Release of access through the device; and

f) Device-internal random change of the at least one device-internal identification.

Thereby, it is advantageous if the random change of at least one device-internal identification is achieved by generating the identification by means of a random number generator.

Alternatively, the random change of at least one device-internal identification can be achieved with the random selection from a predefined list of identifications. Thereby, the transmission of the query key and/or the transmission of the release key can be achieved via data carrier or online data transfer.

In one embodiment, the authorization entity is a computer or other data processing unit, which is accessible to the device manufacturer or an entity authorized by said manufacturer, and which is capable of verifying in known fashion the authorization for the access code request, e.g, through verification of the proper purchase of the device and/or the existence of a service or maintenance agreement and/or if the person, who is authorized to access the data on said device, has requested the access code.

In the following, the invention is explained by means of a particular embodiment.

### BRIEF DESCRIPTION OF THE DRAWINGS

FIG. 1 shows schematically the sequence of the method, according to an embodiment the invention.

### DETAILED DESCRIPTION

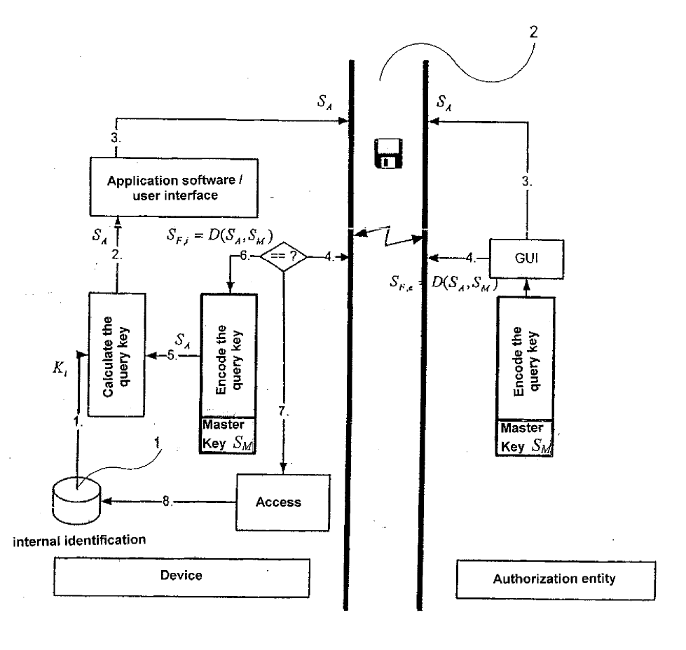

Referring to FIG. 1, the medical device contains a memory 1, which contains at least one (with sufficient probability) unique, preferably unpredictable internal identification Kᵢ. From said identification Kᵢ, a query key S_{A}(Kᵢ) is generated by a computer. This can be a chain of characters or a sequence of numbers or similar combinations of arbitrary length, whereby it is advantageous to use at least 10 characters; alternatively, it can also consist of a byte sequence, which also contains non-displayable characters. Said query key is sent to the authorization entity via a, preferably, secure channel (e.g., mail, telephone, signed email, data carrier). E.g., said authorization entity can be the customer service or service department of the device manufacturer, which is capable of verifying the authorization of the query (identity and authorization of the sender for requesting a new access code). From said query key a release key S_{F,e}=D(S_{A}, S_{M}) is generated by means of a secret masterkey S_{M}; using a suitable encryption method D(S_{A}, S_{M}), e.g., with a computer; in turn, said release key is transmitted via a secure channel back to the respective customer location, which is authorized to change the access code of the device.

The same encryption method and the same (secret) masterkey are implemented in the software of the data-storing device, therefore, the release key S_{F,i}=D(S_{A}, S_{M}) can be calculated internally and not visible for the user. If the comparison of the release key, entered by the user and calculated by the authorization entity results in the parity S_{F,e}=S_{F,I} the access code of the device is reset and the internal identification Kᵢ is selectively, but not predictably, changed. Resetting of the access code can be achieved through various methods, e.g., a previously agreed upon password can be determined, a new valid password is displayed to the user, or temporarily password-free access can be granted, which immediately enforces the definition of a new password.

The repetition of said process on the same/a different device would generate a different query key due to the changed or different internal identification. As a result, the previously used release key is useless, and can therefore not be misused.

The suggested method offers access to protected data independent from the preventive measures of the user, and, in addition, avoids the known disadvantages of a masterkey. Furthermore, the process of authorization (external calculation of the release key) is separated from the operation of the device software, therefore, the presence of a service employee at the device is not required and the number of authorized persons (i.e., the authorized persons for the operation of the external program for generating the release key on the part of the authorization entity) can be drastically reduced when compared to the number of persons, which would require access to a masterkey.

The suggested solution can be expanded in several directions, e.g., through electronic storage and/or transmission of the query key and the release key directly from the device software (e.g., as email or export/import to/from a file).

Furthermore, an automatic change of the internal identification, which is independent from the entry of a valid release key, can be available for certain greater intervals (e.g., once a month). This way, unused release keys would be automatically invalidated after the expired time period and, therefore, pose no risk for unauthorized use.

The method for determining the internal identification Kᵢ can be varied greatly. Feasible examples include:
Combination of timestamp, device identification (e.g., serial number) and a random number;
Use of hash-functions (e.g., MD5 or SHA) for constant user identity data in combination with a random number;
Use of constants (e.g., UID's) from the device operating system in combination with a random number.

Furthermore, the method can be modified or extended for generation and/or comparisons of the release keys. A signature check instead of a parity test is feasible, e.g., through the use of an asymmetrical encryption method, such as RSA, whereby the transmitted query key is encoded in the release key together with the “public” key, and the release key is decoded in the data-storing device by means of the “private” key, and the decoding result is compared to the query key. The terms “public” and “private” keys herein refer to the terminology common in cryptography: In the above case, both keys were to be kept secret.

1. A method for generating an access code for a medical device comprising a memory for patient data or other data to be protected, said access code being valid only once, said method comprising:
a) Device-internal generation of a query key from at least one device-internal identification;
b) Transmission of the query key to an authorization entity;
c) Generation of a release key from the query key through the authorization entity;
d) Transmission of the release key to the device;
e) Release of access through the device; and
f) Device-internal random change of the at least one device-internal identification.

2. The method for generating an access code, according to claim 1, wherein the random change of the at least one device-internal identification is achieved by generating the identification using a random number generator.

3. The method for generating an access code, according to claim 1, characterized in that the random change of the at least one device-internal identification is achieved with a random selection from a predefined list of identifications.

4. The method for generating an access code, according to claim 1, wherein at least one of the transmission of the query key and the transmission of the release key is achieved via data carrier or online data transfer.

5. A method for generating an access code according to claim 2, wherein at least one of the transmission of the query key and the transmission of the release key is achieved via data carrier or online data transfer.

6. A method for generating an access code according to claim 3, wherein at least one of the transmission of the query key and the transmission of the release key is achieved via data carrier or online data transfer.

7. The method of claim 1, wherein the data to be protected is patient data.

8. A secure medical device for selectively protecting patient data, comprising:
a memory for storing patient data to be protected;
means for generating a query key from a device internal identification associated with the secure medical device;
means for transmitting the query key to an authorization entity;
means for receiving a release key from the authorization entity, wherein the release key is generated by the authorization entity using the query key; and
means for changing the device-internal identification following release of access to the data to be protected.

9. The secure medical device of claim 8, further comprising means for changing the access code of the device.

10. The secure medical device of claim 8, wherein the authorization entity is a computer.

11. The secure medical device of claim 8, wherein the authorization entity is associated with a manufacturer of the secure medical device.

12. The secure medical device of claim 8, wherein the device internal identification is a unique identification.

13. A system for selectively protecting patient data, comprising:
a secure medical device including a memory storing patient data, the device adapted to generate and transmit a query key based upon a device-internal identification;
an authorization entity operably coupled to the secure medical device, the authorization entity adapted to receive the query key, generate and transmit a release key based upon the received query key; and
wherein access to the patient data by the secure medical device is allowed upon receipt of a valid release key by the secure medical device, and the device-internal identification is randomly changed such that the release key may not be used a second time.

14. The system of claim 13, wherein the release key comprises at least ten characters.

15. The system of claim 13, wherein the query key and the release key are sent over a secure channel.

16. The system of claim 15, wherein the secure channel is selected from the group consisting of mail, telephone, signed e-mail, and data carrier.
